(19) United States
(12) Patent Application Publication
(10) Pub. No.: US 2018/0029390 A1
(43) Pub. Date: Feb. 1, 2018

(54) Thermal Transfer Printing Spool, Production Method Therefor, Printing Method, And Use Of A Thermal Transfer Printer

(71) Applicant: T.T.R. Euroworks, B.V., Alblasserdam (NL)

(72) Inventor: Everardus Johannes Maria Schaeffer, Alblasserdam (NL)

(21) Appl. No.: 15/552,937

(22) PCT Filed: Feb. 24, 2016
(86) PCT No.: PCT/NL2016/050132

§ 371 Date: Aug. 23, 2017

(30) Foreign Application Priority Data
Feb. 24, 2015 (NL) 2014345

(51) Int. Cl. B41J 17/24; B41M 5/382

(52) U.S. Cl. CPC B41J 17/24; B41M 5/38214

(57) ABSTRACT

The invention relates to a thermal transfer printing spool (201) comprising a tape (203) wound on a core (205) of the spool, said tape having a proximal end (207) connected to the core, a free distal end (209) and a central portion (211) in between the proximal end and the distal end, characterized in that the tape comprises an ink ribbon (213) and a non-self-adhesive substrate ribbon (215), wherein the ink ribbon and the substrate ribbon are arranged on top of each other without being attached to each other in at least the central portion, such that an ink layer of the ink ribbon is in contact with a to be printed top surface of the substrate ribbon. The invention further relates to a method for printing, a production method for the spool, and the use of a thermal transfer printer.

The invention relates to thermal transfer printing in which ink is transferred from an ink ribbon to a substrate by melting the ink so that it stays glued to the substrate on which the print is applied.

A conventional thermal transfer printer typically comprises a thermal print head, a first support for a retrieval core, a second support for a printing spool with substrate ribbon, and a third support for a printing spool with ink ribbon. Printing is carried out by arranging the retrieval core on the first support, arranging a printing spool with substrate ribbon on the second support, and arranging a printing spool with ink ribbon on the third support. The ink ribbon and substrate ribbon are then fed to the thermal print head, so that ink can be transferred from the ink ribbon to the substrate ribbon. After passing the thermal print head, the ink ribbon is fed to the retrieval core, so that during printing the thermal transfer printer only outputs the printed substrate ribbon.

There are different types of thermal print heads. A distinction can be made between types in which heat is generated in the print head itself and subsequently transferred to the ink ribbon and types in which the print head causes heat to be generated in the ink ribbon itself. An example of the latter type is for instance known from EP1.092.561A2 in which a laser causes heat to be generated in the ink ribbon itself. Due to this difference, the ink ribbons used in combination with the different types of print heads are also different as they have to have different properties/characteristics to be suitable. In general, the ink ribbons for use with print heads that cause heat to be generated in the ink ribbon itself have a more complex structure, as the ink ribbon needs to be able to generate heat upon external excitation and it is usually required to have a so-called ejection or subbing layer providing the force to effect transfer of the ink to the corresponding substrate. Ink ribbons for the other type of print heads can be much simpler, in particular when the print head or an additional roller is used to provide the force to effect transfer of the ink. As a result, ink ribbons suitable for one type of print head cannot be used in a printer using the other type of print head and thus specific technical features are not interchangeable.

It is specifically noted here that the invention only relates to ink ribbons, thermal transfer printers and printing methods in which heat is generated in the print head and subsequently transferred to the ink ribbon to melt the ink for transfer to the substrate.

An advantage of thermal transfer printing is that only a few movable parts are required making the printer robust and reliable. Other advantages may be that it can be very fast for monochromatic printing and that the ink can be chosen for waterfastness.

A drawback of a thermal transfer printer is that empty printing spools need to be replaced regularly by filled printing spools resulting in downtime of the printer. Further, filled retrieval cores need to be replaced regularly by empty retrieval cores also resulting in downtime of the printer.

It is therefore an object of the invention to reduce the downtime of thermal transfer printers.

To achieve this object, a thermal transfer printing spool is provided comprising a tape wound on a core of the spool, said tape having a proximal end connected to the core, a free distal end and a central portion in between the proximal end and the distal end, wherein the tape comprises an ink ribbon and a non-self-adhesive substrate ribbon, and wherein the ink ribbon and the substrate ribbon are arranged on top of each other without being attached to each other in at least the central portion, such that an ink layer of the ink ribbon is in contact with a to be printed top surface of the substrate ribbon.

Due to winding both the ink ribbon and the substrate ribbon on a single core of a spool, thereby ensuring that the length of the ink ribbon matches the length of the substrate ribbon, only one spool needs to be replaced instead of two spools in the prior art. This reduces the downtime of the printer considerably.

Combining the ink ribbon and substrate ribbon in one spool is known from for instance international patent publication WO 95/31800 A1. However, this publication relates to self-adhesive substrate ribbons that normally require a release liner. By combining the substrate ribbon and ink ribbon it is possible to use the ink ribbon such that it functions as a conventional release liner, thereby eliminating the use of a separate release liner. In these applications the ink ribbon and the substrate ribbon are attached to each other over substantially the entire length of the tape to properly protect the adhesive layer of the substrate ribbon. However, attaching the ink ribbon to the substrate ribbon is not preferred for non-self-adhesive substrate ribbons, because the ink ribbon always needs to be separated from the substrate ribbon to be retrieved by a retrieval core in the thermal transfer printer. Attaching the ink ribbon and the substrate ribbon thus makes it more difficult to separate the two ribbons when installing the printing spool in the thermal transfer printer and additionally involves the risk of damage to the substrate ribbon or transfer of ink to the substrate ribbon at undesired locations.

Combining ink ribbon and substrate ribbon for non-self-adhesive substrate ribbons in which the ink layer of the ink ribbon is in contact with the to be printed top surface of the substrate ribbon, but not adhered thereto is also not obvious for use in combination with a print head that generates heat itself and then transfers the heat to the ink ribbon due to the prejudice that undesirable ink transfer may occur before printing commences, e.g. caused by unwanted heat generation e.g. as a result of frictional contact between the ink ribbon and substrate ribbon. This is the reason why prior art methods use separate spools and combine the ink ribbon and substrate ribbon just before printing, or make use of the adhesive properties of the substrate ribbon by gluing the ink ribbon to the substrate ribbon to minimize the possibility of mutual movement and thus minimize frictional contact. Ink ribbons e.g. as used in EP1.092.561A2 for other type of print heads do not suffer from this prejudice/problem as it is known that frictional contact is not able to cause enough heat to be generated for these type of inks.

In an embodiment, the top surface of the substrate ribbon comprises a printing region to be printed and a non-printing region which is not to be printed, wherein the ink ribbon covers at least the printing region but not the entire top surface. Preferably, the non-printing region extends at both longitudinal sides of the substrate ribbon with the printing region in between 25 these two longitudinal non-printing areas.

An advantage of this embodiment may be that the non-covered portions of the substrate ribbon can be used to keep the ink ribbon in the correct position thereby minimizing friction. Another advantage may be that the ink ribbon is not easily reached from the outside, thereby minimizing the risk of mutual movement and displacement of the ink ribbon. A further advantage may be that the non-covered portions of the substrate ribbon can be used to manipulate and handle the substrate ribbon without disturbing the ink ribbon. In this way, the ink ribbon is able to passively follow the substrate ribbon during printing and can easily be removed from the substrate ribbon after printing.

The invention also relates to a method for printing, comprising the following steps:
a. providing a thermal transfer printer with a thermal print head, a first support for a retrieval core and a second support for a printing spool;
b. providing a retrieval core on the first support;
c. providing a thermal transfer printing spool according to the invention on the second support;
d. feeding the distal end of the tape to the thermal print head;
e. connecting the ink ribbon to the retrieval core; and
f. transferring ink from the ink ribbon to the substrate ribbon in the thermal print head.

In an embodiment, after transferring ink from the ink ribbon to the substrate ribbon, the ink ribbon is separated from the substrate ribbon and fed to the retrieval core.

The invention further relates to the use of a thermal transfer printer comprising a thermal print head, a first support for a retrieval core, a second support for a printing spool with substrate ribbon, and a third support for a printing spool with ink ribbon, said use being characterized by using only one of the second and third supports for supporting a thermal transfer printing spool according to the invention.

The invention also relates to a method for producing a thermal transfer printing spool, comprising the following steps:
a. providing a non-self-adhesive substrate ribbon;
b. providing an ink ribbon;
c. forming a tape by arranging the ink ribbon and the substrate ribbon on top of each other without being attached to each other in at least a central portion of the tape, such that an ink layer of the ink ribbon is in contact with a to be printed top surface of the substrate ribbon;
d. connecting a proximal end of the tape to a core of the spool; and
e. winding the tape on the core of the spool.

In an embodiment, providing the substrate ribbon and the ink ribbon respectively comprises cutting a main substrate body and a main ink body into substrate ribbons and ink ribbons of the desired width for parallel production of multiple thermal transfer printing spools, and wherein cutting is carried out prior to the forming of the tape.

In an embodiment, the substrate ribbon and the ink ribbon are provided as parts of respectively a main substrate body and a main ink body to simultaneously produce multiple thermal transfer printing spools, wherein the tape is formed by arranging the main substrate body on top of the main ink body, and wherein after forming the tape, the tape is cut to the desired width before being wound onto the core of the spool.

In an embodiment, the tensions applied to the ink ribbon and the substrate ribbon during the formation of the tape are controlled such that relative movement, and thus frictional contact, between the two ribbons is minimal.

Although not explicitly mentioned, it will be apparent for the skilled person that the invention relates to applications in which only a single layer of ink is used to transfer ink to a substrate, i.e. monochrome applications, and does not relate to multi-color applications as it is not possible to combine all different ink layers on one spool and independently control the transfer of ink of each layer. However, please note that this does not imply that the end-product should be monochromatic as well. It is for instance possible to work with preprinted substrate ribbons to obtain a multi-colored end product.

The invention will now be described in a non-limiting way by reference to the accompanying drawings in which:

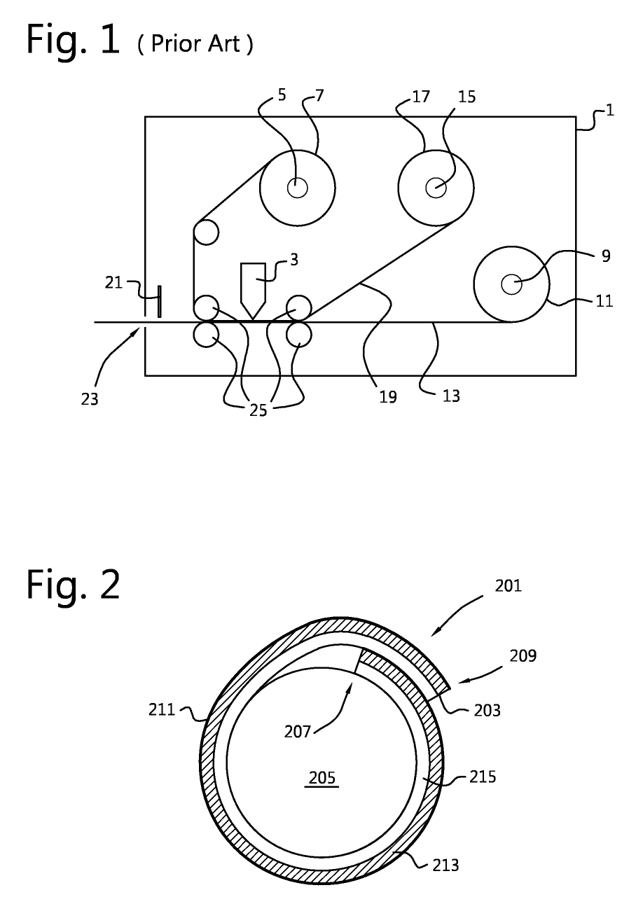

FIG. 1 depicts a schematic internal view of a prior art thermal transfer printer;

FIG. 2 depicts a side view of a thermal transfer printing spool according to an embodiment of the invention;

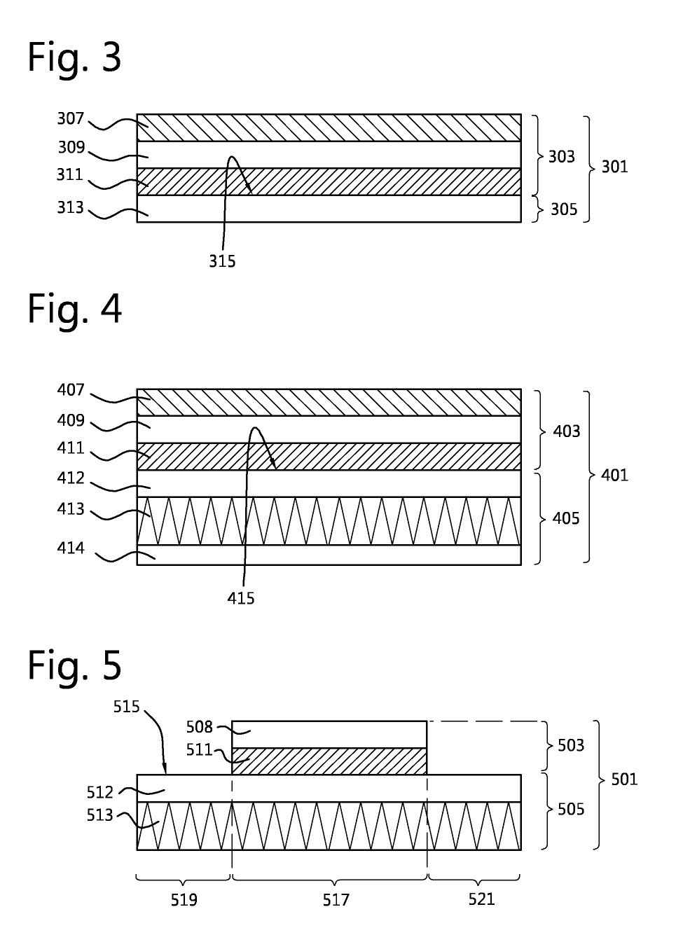

FIG. 3 depicts a cross sectional view of a tape of a thermal transfer printing spool according to another embodiment of the invention;

FIG. 4 depicts a cross sectional view of a tape of a thermal transfer printing spool according to a further embodiment of the invention; and

FIG. 5 depicts a cross sectional view of a tape of a thermal transfer printing spool according to yet another embodiment of the invention.

FIG. 1 depicts a schematic internal view of a prior art thermal transfer printer 1 comprising a thermal print head 3, a first support 5 for a retrieval core 7, a second support 9 for a printing spool 11 with substrate ribbon 13, and a third support 15 for a printing spool 17 with ink ribbon 19.

The printing spools 11 and 17 and the retrieval core 7 are exchangeable, so that empty printing spools can be replaced by filled printing spools and filled retrieval cores can be replaced by empty retrieval cores.

Printing spool 11 is arranged at second support 9 to be rotatably supported. Unwinding the printing spool 11 allows the substrate ribbon 13 wound on the printing spool 11 to be fed to the thermal print head 3 and out of the thermal transfer printer 1.

Printing spool 17 is arranged at third support 15 to be rotatably supported. Unwinding the printing spool 17 allows the ink ribbon 19 wound on the printing spool 17 to be fed to the thermal print head 3, such that the ink ribbon 19 is in between the thermal print head 3 and the substrate ribbon 13, and to be connected to the retrieval core 7 rotatably supported at the first support 5.

In the prior art thermal transfer printer 1 as depicted in FIG. 1, the ink ribbon 19 and the substrate ribbon 13 are provided separately, combined at the thermal print head 3, such that an ink layer of the ink ribbon 19 is in contact with a to be printed top surface of the substrate ribbon 13, and subsequently separated again, such that residual ink ribbon is retrieved at the retrieval core, possibly for recycle purposes, and a printed substrate is outputted from the thermal transfer printer.

Optionally, a cutter 21 may be provided at the exit 23 to separate printed substrate ribbon from the not yet printed substrate ribbon in the thermal transfer printer 1. The cutter 21 may be embodied as a knife blade that can be moved up and down to cut through the substrate ribbon. The cutter 21 can be positioned outside the housing of the thermal transfer printer 1 and may even be provided such that it does not form an integral part of the thermal transfer printer 1, but may also be positioned inside the thermal transfer printer 1 as depicted in FIG. 1.

Combining the ink ribbon 19 and the substrate ribbon 13 may be aided or carried out using pairs of guide rollers 25 downstream and upstream of the thermal print head 3. While the combined substrate ribbon 13 and the ink ribbon 19 pass the thermal print head 3, the thermal print head 3 applies heat to the ink ribbon 19 in a pattern corresponding to a printing pattern to be transferred to the substrate ribbon 13, thereby melting the ink layer locally, which melted areas of the ink layer 19 subsequently stay glued to the substrate ribbon 13 and become permanently attached to the substrate ribbon 13 when the ink solidifies again.

A main drawback associated with the prior art thermal transfer printer 1 of FIG. 1 is that there is considerable downtime due to the replacing of the retrieval core 7 and the printing spools 11, 17. Especially at a manufacturing site with multiple thermal transfer printers 1 working in parallel, it may well be that dedicated personnel is required to constantly replace retrieval cores and printing spools to keep the manufacturing going.

In order to reduce the downtime of thermal transfer printers such as thermal transfer printer 1 of FIG. 1, the inventors have provided a thermal transfer printing spool in which the ink ribbon and substrate ribbon are combined. A side view of a thermal transfer printing spool according to the invention is shown in FIG. 2. In this figure, the length of the ribbons is deliberately chosen to be short, namely slightly more than one winding, in order to clearly show the structure of the spool.

FIG. 2 depicts a schematic side view of a thermal transfer printing spool 201 comprising a tape 203 wound on a core 205 of the spool 201. The tape 203 has a proximal end 207 connected to the core 205, a free distal end 209 and a central portion 211 in between the proximal end 207 and the distal end 209. The length of the central portion 211 is about one winding, but it will be clear for the skilled person that the length of the central portion can easily be multiple windings long, which is preferred from an operational point of view as the longer the tape is, the less downtime there is to replace a printing spool as the printing spool lasts longer.

The tape 203 comprises an ink ribbon 213 and a non-self-adhesive substrate ribbon 215. The ink ribbon is indicated here as the shaded part of the tape 203, and the substrate ribbon 215 is indicated here as the non-shaded part of the tape 203. The ink ribbon 213 and the substrate ribbon 215 are arranged on top of each other without being attached to each other in at least the central portion.

The proximal end 207 may alternatively be referred to as a trailer. The trailer may have a different composition than the central portion contrary to what is shown in FIG. 2. For instance, as is known in the art, the proximal end may comprise a transparent portion and a non-transparent portion, e.g. silver colored portion, which are used to connect the central portion with the ink ribbon and the substrate ribbon to the core 205, and which may be used to allow the thermal transfer printer to determine that the printing spool is empty or nearly empty.

The distal end 209 may alternatively be referred to as leader. The leader may have a different composition than the central portion contrary to what is shown in FIG. 2. For instance, as is known in the art, the leader may comprise a foil which may form the outer winding on the spool. The leader can then be used to handle the ink ribbon and substrate ribbon when installing the printing spool in a thermal transfer printer and/or may form a protective outer layer for the printing spool during transport, etc.

Three examples of the specific structure of the tape 203 will be described below with reference to FIGS. 3 to 5.

FIG. 3 depicts a cross sectional view of a tape 301 according to a first embodiment and suitable to be used in the thermal transfer printing spool of FIG. 2. The tape 301 comprises an ink ribbon 303 and a non-self-adhesive substrate ribbon 305.

In this embodiment, the ink ribbon 303 comprises of three layers arranged on top of each other and attached to each other to form a single element. The three layers are respectively a silicon layer 307, a polyester layer 309 and an ink layer 311. The silicon layer 307 and polyester layer 309 are used as carrier layers for the ink layer 311 and may also be composed of other materials.

In the embodiment of FIG. 3, the substrate ribbon 305 consist of a single substrate layer 313 with a top surface 315, and may for instance be nylon or a fabric. The top surface 315 is the surface intended to be printed on. The ink ribbon 303 and the substrate ribbon 305 are arranged on top of each other without being attached to each other in at least the central portion of the tape 301. This means amongst others that there are no significant adhesive forces between the ink ribbon and substrate ribbon caused by adhesives. This has the advantage that after passing the thermal print head of a thermal transfer printer, the ink ribbon can easily be separated from the substrate ribbon for retrieval of the residual ink ribbon after printing.

The substrate ribbon and the ink ribbon are arranged on top of each other such that the ink layer 311 of the ink ribbon 303 is in contact with the top surface 315 of the substrate ribbon 305. Hence, the ink ribbon and the substrate ribbon are already combined on the spool as they are combined for printing purposes in prior art thermal transfer printers, see FIG. 1.

FIG. 4 depicts a cross sectional view of a tape 401 according to a second embodiment and suitable to be used in the thermal transfer printing spool of FIG. 2. The tape 401 comprises an ink ribbon 403 and a non-self-adhesive substrate ribbon 405.

In this embodiment, the ink ribbon 403 comprises three layers arranged on top of each other and attached to each other to form a single element. The three layers are respectively a silicon layer 407, a polyester layer 409 and an ink layer 411. The silicon layer 407 and polyester layer 409 are used as carrier layers for the ink layer 411 and may also be composed of other materials.

The substrate ribbon 305 comprises a substrate layer 413, which may for instance be paper or plastic. In this embodiment, the substrate layer 413 comprises a respective preprinted layer 412, 414 on both sides of the substrate layer 413. The preprinted layers 412, 414 are attached to the substrate layer 413 to form a single element. Due to the preprinted layer 412, this layer comprises a to be printed top surface 415. The substrate layer may also be covered with layers, for instance coatings, in addition or alternative to the preprinted layers 412, 414.

In this embodiment, the ink ribbon 403 and the substrate 405 are arranged on top of each other without being attached to each other in at least the central portion of the tap 401. This means amongst others that there are no significant adhesive forces between the ink ribbon and substrate ribbon caused by adhesives. This has the advantage that after passing the thermal print head of a thermal transfer printer, the ink ribbon can easily be separated from the substrate ribbon for retrieval of the residual ink ribbon after printing.

The substrate ribbon 405 and the ink ribbon 403 are arranged on top of each other such that the ink layer 411 of the ink ribbon 403 is in contact with the top surface 415 of the substrate ribbon 405.

FIG. 5 depicts a cross sectional view of a tape 501 according to a third embodiment and suitable to be used in the thermal transfer printing spool of FIG. 2. The tape 501 comprises an ink ribbon 503 and a non-self-adhesive substrate ribbon 505.

In this embodiment, the ink ribbon 503 comprises an ink layer 511 attached to a single carrier layer 508 to form a single element.

The substrate ribbon 505 comprises a substrate layer 513 with a coating 512 on top of the substrate layer 513. The coating 512 is attached to the substrate layer 513 to form a single element. The coating 512 also defines a top surface 515 of the substrate ribbon 505.

In this embodiment, the substrate ribbon 505 comprises a central portion 517 and two side portions 519, 521 on opposite sides of the central portion 517. The top surface 515 of the central portion 517 of the substrate ribbon 505 forms a printing region to be printed. The top surface 515 of the side portions 519, 521 of the substrate ribbon 505 form non-printing regions which are not to be printed.

Due to the printing and non-printing regions, the ink ribbon does not have to cover the entire top surface 515, but at least the printing region associated with the central portion 517. This has been shown in FIG. 5. The ink ribbon 403 is arranged on top of the central portion 517 of the substrate ribbon 505 only. As with the embodiments of FIGS. 3 and 4, the ink ribbon and substrate ribbon are not attached to each other. Further, the ink ribbon 503 and the substrate ribbon 505 are arranged on top of each other such that the ink layer 511 of the ink ribbon 503 is in contact with the top surface 515 of the substrate ribbon 505.

The thermal transfer printing spool of FIG. 2 can be produced by providing a non-self-adhesive substrate ribbon and an ink ribbon, and subsequently forming a tape by arranging the ink ribbon and the substrate ribbon on top of each other without being attached to each other in at least a central portion of the tape, such that an ink later of the ink ribbon is in contact with a to be printed top surface of the substrate ribbon as for example shown in FIGS. 3-5. A proximal end of the tape is then connected to a core of the spool and the tape is wound on the core of the spool.

It is possible to produce multiple thermal transfer printing spools in parallel by using wide main substrate bodies and main ink bodies, which can be cut to the desired width prior to forming the tape, or which can be combined to form a wide tape which is cut to the desired width after forming the wide tape.

The thermal transfer printing spool can be used in a prior art thermal transfer printer as for instance shown in FIG. 1 to replace the printing spools 11 and 17. The second support 9 or the third support 15 can then be used to support the printing spool 201 of FIG. 2. The distal end 209 of the spool 201 can be fed to the thermal print head 3, after which the ink ribbon is connected to the retrieval core. Transferring ink from the ink ribbon to the substrate ribbon in the thermal print head can then be done in the conventional way.

Besides using the thermal transfer printing spool in prior art thermal transfer printers that originally have separate supports for the ink and the substrate, it is also possible to use the spool in thermal transfer printers that only have a single support for the ink and substrate.

It will be well understood that the substrate ribbon may comprise a substrate layer composed of many different materials, including but not limited to paper, carton, plastic, fabric, composite materials, or any combination thereof.

Further, the thickness of the substrate ribbon can be any practical thickness that can be handled by a thermal transfer printer.

As shown above in relation to FIGS. 3-5, it is preferred that the ink ribbon may comprise an additional layer adjacent the ink layer. An advantage may be that the print head can transfer the heat to the additional layer and via the additional layer to the ink layer without directly contacting the ink layer and thus without the risk of ink adhering to the print head. Another advantage is that the retrieval of non-transferred ink is ensured even when a relatively large portion of the ink layer is transferred. If no additional layer was provided, there would be a risk of breakage of the ink layer compromising the retrieval operation. As the additional layer remains intact at all times during the printing process, this risk is minimized.

Although not explicitly shown in the drawings, it is clear for the skilled person that a spool comprising a substrate ribbon which has two to be printed top surfaces on either side of the substrate, wherein a respective ink ribbon is provided on either side of the substrate ribbon in accordance with the invention to be in contact with the opposite to be printed top surfaces of the substrate ribbon also falls within the scope of the invention. Such a spool can then be advantageously used with a thermal transfer printer comprising two print heads, one for each to be printed top surface, which print heads may be arranged on opposite sides of the tape or the tape is turned upside down in between the print heads when the print heads are arranged on the same side.

1. A thermal transfer printing spool comprising a tape wound on a core of the spool, said tape having a proximal end connected to the core, a free distal end and a central portion in between the proximal end and the distal end, characterized in that the tape comprises an ink ribbon and a non-self-adhesive substrate ribbon, wherein the ink ribbon and the substrate ribbon are arranged on top of each other without being attached to each other in at least the central portion, such that an ink layer of the ink ribbon is in contact with a to be printed top surface of the substrate ribbon.

2. A printing spool according to claim 1, wherein the top surface of the substrate ribbon comprises a printing region to be printed and a non-printing region which is not to be printed, and wherein the ink ribbon covers at least the printing region but not the entire top surface.

3. A method for printing, comprising the following steps:
a. providing a thermal transfer printer with a thermal print head, a first support for a retrieval core and a second support for a printing spool;
b. providing a retrieval core on the first support;
c. providing a thermal transfer printing spool according to claim 1 on the second support;
d. feeding the distal end of the tape to the thermal print head;
e. connecting the ink ribbon to the retrieval core; and
f. transferring ink from the ink ribbon to the substrate ribbon in the thermal print head.

4. Use of a thermal transfer printer comprising a thermal print head, a first support for a retrieval core, a second support for a printing spool with substrate ribbon, and a third support for a printing spool with ink ribbon, said use being characterized by using only one of the second and third supports for supporting a thermal transfer printing spool according to claim 1.

5. A method for producing a thermal transfer printing spool, comprising the following steps:
a. providing a non-self-adhesive substrate ribbon;
b. providing an ink ribbon;
c. forming a tape by arranging the ink ribbon and the substrate ribbon on top of each other without being attached to each other in at least a central portion of the tape, such that an ink layer of the ink ribbon is in contact with a to be printed top surface of the substrate ribbon;
d. connecting a proximal end of the tape to a core of the spool; and
e. winding the tape on the core of the spool.

6. A method according to claim 5, wherein providing the substrate ribbon and the ink ribbon respectively comprises cutting a main substrate body and a main ink body into substrate ribbons and ink ribbons of the desired width for parallel production of multiple thermal transfer printing spools, and wherein cutting is carried out prior to the forming of the tape.

7. A method according to claim 5, wherein the substrate ribbon and the ink ribbon are provided as parts of respectively a main substrate body and a main ink body to simultaneously produce multiple thermal transfer printing spools, wherein the tape is formed by arranging the main substrate body on top of the main ink body, and wherein after forming the tape, the tape is cut to the desired width before being wound onto the core of the spool.
